(19) United States
(12) Patent Application Publication
(10) Pub. No.: US 2026/0249965 A1
(43) Pub. Date: Aug. 27, 2026

(54) BOAT MANUFACTURING ARRANGEMENT, BOAT AND METHOD OF MANUFACTURING A BOAT

(71) Applicant: PÄIJÄN BOATS OY, Lahti (FI)

(72) Inventor: Jarmo MERISALO, Vääksy (FI)

(21) Appl. No.: 18/872,681

(22) PCT Filed: Jun. 7, 2023
(86) PCT No.: PCT/FI2023/050331

§ 371 Date: Dec. 6, 2024

(30) Foreign Application Priority Data
Jun. 9, 2022 (FI) 20225509

(51) Int. Cl. B63B 73/70; B63B 5/24

(52) U.S. Cl. CPC B63B 73/70; B63B 5/24

(57) ABSTRACT

The object of the invention is a boat with improved water movement properties. The boat comprises at least one outer mold (100) and at least one inner mold (102) according to the model of the boat to form a double-shell structure, the molds (100, 102) comprising a first hole (103a) through which closed-cell polyurethane has been sprayed with a high-pressure sprayer to fill the empty spaces (100, 102) inside the molds, and a second hole (103 b) through which air has been removed from the empty spaces during said spraying. The boat comprises a rounded design of the stem (107), a shape of the bottom so that the bottom is widest at the front of the boat (109) to reduce water resistance, and as said spaces filled with closed-cell polyurethane side floats (105) on the sides of the boat to stiffen the hull with said closed-cell polyurethane. Further, the boat comprises a keel part (115) containing heavy material as a keel weight.

### FIELD OF THE INVENTION

The invention is related to rowing boats, motorboats and to the manufacture of said boats.

### PRIOR ART

Numerous different models of plastic and fiberglass boats are known. The biggest challenges in their characteristics are directed to safety, carrying capacity and swimming properties. One essential feature in their characteristics is the seaworthiness approval, where important properties are required from the boats during regulatory inspections. Seaworthiness approval is granted to only quite a few boats in the size class of rowing boats.

Boat manufacturing technology according to prior art primarily aims at manufacturing efficiency and cost savings.

### BRIEF DESCRIPTION OF THE INVENTION

The object of the invention is a new type of boat manufacturing technology and a boat with advanced swimming, carrying capacity and durability properties. This is achieved by the boat manufacturing arrangement according to the invention. The boat manufacturing arrangement comprises at least one outer mold and at least one inner mold according to the model of the boat being manufactured to form a double-shell structure, the molds comprising shapes for forming side floats and benches as empty spaces, a rounded design of the stern of the boat, a shape of the bottom so that the bottom is widest at the front of the boat to reduce water resistance, holes to fill the empty spaces with closed-cell polyurethane and to remove air from the empty spaces, and as said empty spaces side floats on the sides of the boat to stiffen the hull of the boat with said closed-cell polyurethane, and the boat manufacturing arrangement comprises application means for making a wet surface, means for connecting said at least one outer mold and at least one inner mold to each other with a wet joint, a high-pressure sprayer to fill the empty spaces after drying with closed-cell polyurethane through the first hole and to remove air from the empty spaces through the second hole, and installation tools for installing heavy material as a keel weight.

The object of the invention is also a boat with improved water movement properties. The boat comprises at least one outer mold and at least one inner mold according to the model of the boat to form a double-shell structure, the molds comprising a first hole through which closed-cell polyurethane has been sprayed with a high-pressure sprayer to fill the side floats and benches as empty spaces inside the molds, and a second hole through which air has been removed from the empty spaces during said spraying, and the boat comprises a rounded design of the stern, a shape of the bottom so that the bottom is widest at the front of the boat to reduce water resistance, and as said spaces filled with closed-cell polyurethane side floats on the sides of the boat to stiffen the hull with said closed-cell polyurethane, and a keel part containing heavy material as a keel weight.

The object of the invention is also a boat manufacturing method, wherein a double-shell structure is formed with at least one outer mold and at least one inner mold according to the model of the boat being manufactured, the molds comprising the shapes for forming side floats and benches as empty spaces, wet surfaces are formed, said at least one outer mold and at least one inner mold are connected to each other with a wet joint, the empty spaces are filled after drying by high-pressure spraying of closed-cell polyurethane through the first hole and during filling air is removed from the empty spaces through the second hole, the hull of the boat is stiffened during the filling of said closed-cell polyurethane by filling the side floats as empty spaces on the sides of the boat with said closed-cell polyurethane, and the keel part containing heavy material is installed as a keel weight.

The invention is based on at least one outer mold and at least one inner mold according to the model of the boat to form a double-shell structure, the molds comprising a first hole through which closed-cell polyurethane has been sprayed with a high-pressure sprayer to fill the empty spaces inside the molds, and a second hole through which air has been removed from the empty spaces during said spraying. The invention is also based on the fact that said spaces filled with closed-cell polyurethane are the side floats on the sides of the boat to stiffen the hull with said closed-cell polyurethane. The keel part containing heavy material can be used as a keel weight of the boat.

The advantage of the invention is that its swimming properties and carrying capacity are better than in similar boats of the same size category. The boat is unsinkable in all conditions.

### LIST OF THE DRAWINGS

FIG. 1A shows the inner mold of the boat according to the invention.

FIG. 1B shows the outer mold of the boat according to the invention.

FIG. 2 shows a boat according to the invention.

### DETAILED DESCRIPTION OF THE INVENTION

In the boat manufacturing arrangement according to the invention and the method according to it, outer and inner molds are used as boat molds to form the boat. The material of the molds is preferably fiberglass. The weight of one mold is preferably around 200 kg to 350 kg. In manufacturing, two-component spray painting and spraying of the inner and outer surfaces of the molds can be performed with, for example, resin and/or glass. The rolling can be carried out cheaply by hand, so that no air remains between the paint and the fiberglass. Feed-throughs are made for the benches using, for example, pipes, and the foot pegs are reinforced.

By performing grinding, it is ensured that the molds adhere to each other and fit together as perfectly as possible. A wet joint can be advantageously formed with pneumatic presses, and the molds can be joined together while wet. After drying, a high-pressure spraying of closed-cell polyurethane is performed with a high-pressure sprayer into the empty spaces between the connected inner and outer molds, such as floats and benches. For spraying with a high-pressure sprayer, the outer mold has a filling hole for closed-cell polyurethane and an exhaust hole for air to escape from between the inner and outer molds. After this, a removal from the manufacturing structures can be done and the boat comprising the inner and outer mold has been formed. In the next manufacturing step, fittings and other finishings can be carried out, and the hatches and hooks etc. are attached and finished.

Closed-cell polyurethane is an advantageous material because it does not absorb water, and thus it can be used to ensure the unsinkability the boat, even if the boat breaks. Polyurethanes and other materials with similar properties can also be defined more broadly as material suitable for implementations according to the invention. In the design of the boat according to the invention, by shaping the bottom an increase in the side weight from the extreme side is achieved. This design of the boat means that the bottom of the boat has a flat portion, for example 15 cm to 40 cm. The maximum achievable side weight can be, for example, 70 kg to 120 kg. By increasing the weight of the keel, the maximum achievable side weight can also be increased. The boat has side floats filled with closed-cell polyurethane, which gives stability, buoyancy and thereby increase in safety and usability both as a storage space and to facilitate movement. Side floats also stiffen the hull improving its durability. The inner surfaces of the side floats are shaped so that water flows from them to the bottom, which makes it easier to e.g. remove rainwater from the boat. A raised side structure can be built into the boat to increase stability. The keel of the boat according to the invention is preferably formed to a height of, for example, 5 cm from bow to stern in order to increase the directional stability of swimming. For example, steel can be used as a keel weight to increase the weight below the water line, by which an increase in the boat's carrying capacity and an increase in the maximum number of people allowed, for example, from three to four people, has been achieved. Then the boat swims better and is also considerably more durable. The rounded design of the stern allows for greater carrying capacity and the use of a larger permitted motor, for example 4 hp/3 KW or larger. The boat can be equipped with a “claw plate”, i.e. a shaped widening profile at the stem, so that the engine does not fall into the water but a dangerous situation is noticed earlier. In order to develop functionality, the boat can be made with feed-throughs for wiring.

Roughings can be made to the inner bottom and benches of the boat to increase usability and safety.

The bottom of the boat according to the invention is advantageously formed in such a way that it is at its widest at the front bench, and this enables a reduction in water resistance, since no water wake turbulence is formed. A recess can be formed in the bow as a safety feature to make it easier to get ashored, because the center of gravity moves as low as possible. Another advantageous feature of the boat is that the edge of the boat can be made semi-circular, so that the splashes do not come in but are steered outwards.

Advantageously, fiberglass as the material for the inner and outer molds and the double-shell structure formed with the inner and outer molds and the boat's rigidity reinforced with closed-cell polypropylene form a very strong boat. It is easy to add accessories, such as a bow motor, a stand, an echo sounder with stands, etc.

Among the other possible and advantageous features of the boat according to the invention can be mentioned: Foot pegs to facilitate rowing, for example 10 pieces, a rescue handle for those fallen into the water and an ergonomic bow hook. Boxes can be placed under the benches for all kinds of storage, such as batteries, fishes, drinks, etc.

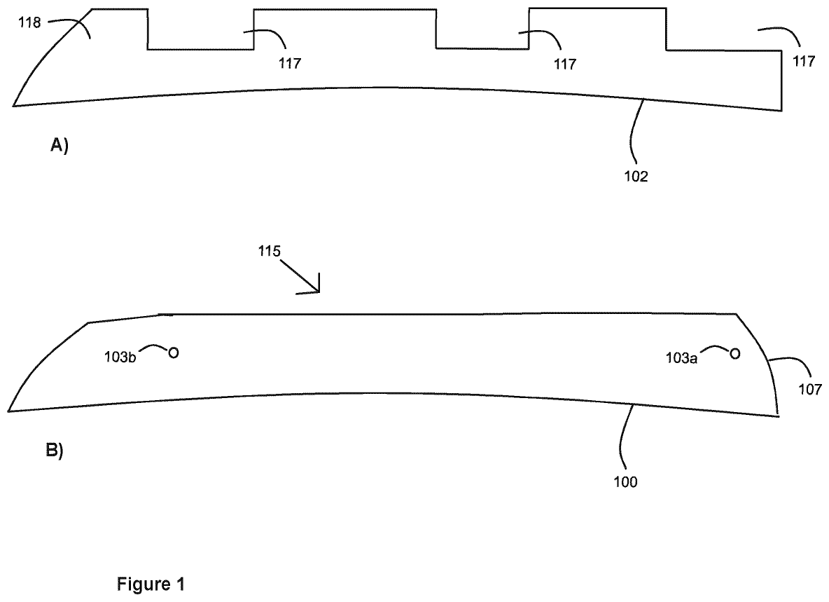

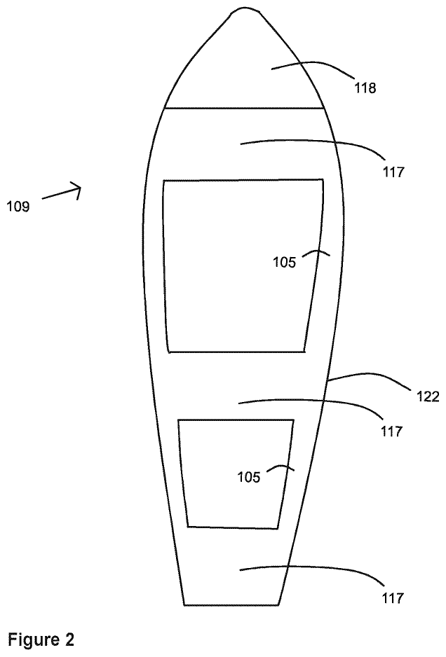

Next, preferred embodiments of the invention are presented with reference to the exemplary FIGS. 1-2. The boat manufacturing arrangement comprises at least one outer mold 100 and at least one inner mold 102 according to the model of the boat being manufactured to form a double-shell structure. The molds 100, 102 comprise shapes for forming empty spaces, a rounded design 107 of the stern of the boat and a shape of the bottom so that the bottom is widest at the front of the boat 109 to reduce water resistance. The molds also comprise holes 103 for filling the empty spaces with closed-cell polyurethane and for removing air from the empty spaces. The said empty spaces are preferably the side floats 105 on the sides of the boat to stiffen the hull of the boat with said closed-cell polyurethane. The said empty spaces can also be, for example, benches 117. The boat manufacturing arrangement comprises application means for making a wet surface and pressing means for connecting said at least one outer mold 100 and at least one inner mold 102 to each other with a wet joint. Preferably, wet polyester resin and/or fiberglass is applied to the outer mold or the inner mold or both with the application means to connect the outer and inner molds to each other. The pressing means can comprise a pneumatic press for connecting said at least one outer mold 100 and at least one inner mold 102 to each other with a wet joint.

The boat manufacturing arrangement also comprises a high-pressure sprayer to fill the empty spaces after drying with closed-cell polyurethane through the first hole 103a and to remove air from the empty spaces through the second hole 103b. The keel part 115 containing heavy material is installed as a keel weight with the installation means. Preferably, this is done by spraying resin on the bottom of the keel, into which rebar is embedded. The resin adds extra weight to the keel and prevents corrosion of the rebar if the keel is damaged from the outside. In preferred embodiments of the invention, the boat manufacturing arrangement comprises grinding means for grinding the surfaces of at least one outer mold 100 and at least one inner mold 102 to enhance their adhesion to each other.

In the boat manufacturing method according to the invention, a double-shell structure is formed with at least one outer mold 100 and at least one inner mold 102 according to the model of the boat being manufactured, the molds 100, 102 comprising the shapes for forming empty spaces. In the next step, the wet surfaces are formed, the said at least one outer mold 100 and at least one inner mold 102 are connected to each other with a wet joint. The empty spaces are preferably filled after drying by high-pressure spraying of closed-cell polyurethane through the first hole 103a, and during filling, air is removed from the empty spaces through the second hole 103b. In this way, the hull is stiffened during the filling of said closed-cell polyurethane by filling the side floats 105 as empty spaces on the sides of the boat with said closed-cell polyurethane. In the manufacturing method, a keel part 115 containing heavy material can also be installed as a keel weight.

The boat according to the preferred embodiments of the invention shown in FIGS. 1-2 comprises at least one outer mold 100 and at least one inner mold 102 according to the model of the boat to form a double-shell structure. The molds 100, 102 comprise a first hole 103a, through which closed-cell polyurethane has been sprayed with a high-pressure sprayer to fill the empty spaces inside the molds 100, 102, and a second hole 103b, through which air has been removed from the empty spaces during said spraying. The boat comprises a rounded design 107 of the stern and a shape of the bottom so that the bottom is widest at the front of the boat 109 to reduce water resistance. Said spaces filled with closed-cell polyurethane are the side floats 105 on the sides of the boat to stiffen the hull of the boat with said closed-cell polyurethane. The boat can also advantageously comprise a keel part 115 comprising heavy material as a keel weight.

Said empty spaces before filling are preferably side floats 105 and benches 117. The boat according to the invention can comprise a flat middle portion 119 at the bottom to increase the maximum permissible side weight. The boat can also have a recess 118 located in the bow to form the center of gravity as low as possible when getting ashored.

The stern of the boat according to the invention can have a shaped profile 120 to prevent the outboard motor from falling into the water. In addition, an advantageous feature of the boat can be semi-elliptical boat edges 122 to guide the waves away from the boat.

1. A boat manufacturing arrangement, characterized in that the boat manufacturing arrangement comprises at least one outer mold (100) and at least one inner mold (102) according to the model of the boat being manufactured to form a double-shell structure, the molds (100, 102) comprising shapes for forming side floats (105) and benches (117) as empty spaces, a rounded design of the stern of the boat (107), a shape of the bottom so that the bottom is widest at the front of the boat (109) to reduce water resistance, holes (103) to fill the empty spaces with closed-cell polyurethane and to remove air from the empty spaces, and as said empty spaces side floats (105) on the sides of the boat to stiffen the hull of the boat with said closed-cell polyurethane, and the boat manufacturing arrangement comprises application means for making a wet surface, means for connecting said at least one outer mold (100) and at least one inner mold (102) to each other with a wet joint, a high-pressure sprayer for filling the empty spaces after drying with closed-cell polyurethane through the first hole (103a) and for removing air from the empty spaces through the second hole (103b), and installation means for installing a keel part (115) containing heavy material as a keel weight.

2. The boat manufacturing arrangement according to claim 1, characterized in that the boat manufacturing arrangement comprises grinding means for grinding the surfaces of at least one outer mold (100) and at least one inner mold (102) to enhance their adhesion to each other.

3. The boat manufacturing arrangement according to claim 1, characterized in that pressing means comprise a pneumatic press for connecting said at least one outer mold (100) and at least one inner mold (102) to each other with a wet joint.

4. A boat with improved water movement properties, characterized in that the boat comprises at least one outer mold (100) and at least one inner mold (102) according to the model of the boat to form a double-shell structure, the molds (100, 102) comprising a first hole (103a) through which closed-cell polyurethane has been sprayed with a high-pressure sprayer to fill the side floats (105) and benches (117) as empty spaces inside the molds (100, 102), and a second hole (103b) through which air has been removed from the empty spaces during said spraying, and the boat comprises a rounded design of the stern of the boat (107), a shape of the bottom so that the bottom is widest at the front of the boat (109) to reduce water resistance, and as said spaces filled with closed-cell polyurethane the side floats (105) on the sides of the boat to stiffen the hull of the boat with said closed-cell polyurethane, and a keel part

(115) containing heavy material as a keel weight.

5. The boat according to claim 4, characterized in that the boat comprises a flat central portion (119) at the bottom in order to increase the maximum permitted side weight.

6. The boat according to claim 4, characterized in that the boat comprises a recess (118) located in the bow to form the center of gravity as low as possible when getting ashored.

7. The boat according to claim 4, characterized in that the boat comprises a shaped profile in the stern of the boat to prevent the outboard motor from falling into the water.

8. The boat according to claim 4, characterized in that the boat comprises semi-elliptical boat edges (122) to guide the waves away from the boat.

9. A boat manufacturing method, characterized in that in the method a double-shell structure is formed with at least one outer mold (100) and at least one inner mold (102) according to the model of the boat being manufactured, the molds (100, 102) comprising shapes for forming side floats (105) and benches (117) as empty spaces, wet surfaces are formed, said at least one outer mold (100) and at least one inner mold (102) are connected to each other with a wet joint, the empty spaces are filled after drying by high-pressure spraying of closed-cell polyurethane through the first hole (103a) and during filling, air is removed from the empty spaces through the second hole (103b), the hull of the boat is stiffened during the filling of said closed-cell polyurethane by filling the side floats (105) as empty spaces on the sides of the boat with said closed-polyurethane, and a keel part (115) comprising heavy material is installed keel weight.
